(19) United States
(12) Patent Application Publication
(10) Pub. No.: US 2026/0163967 A1
(43) Pub. Date: Jun. 11, 2026

(54) BACK-ATTACHED DISPLAY APPARATUS FOR MOBILE PHONE SELFIE TAKING

(71) Applicant: Shenzhen Cynova Technology Co., Ltd, Shenzhen (CN)

(72) Inventor: Huaicheng Hui, Shenzhen (CN)

(73) Assignee: Shenzhen Cynova Technology Co., Ltd, Shenzhen (CN)

(21) Appl. No.: 19/328,290

(22) Filed: Sep. 15, 2025

(30) Foreign Application Priority Data
Dec. 10, 2024 (CN) 202411809386.0

(51) Int. Cl. H04M 1/02; G03B 17/56; G03B 30/00; H04M 1/72412; H04M 1/72415; H04M 1/72466; H04N 23/53; H04N 23/63

(52) U.S. Cl. CPC H04M 1/0256; G03B 17/56; G03B 30/00; H04M 1/72412; H04M 1/72415; H04M 1/72466; H04N 23/53; H04N 23/631; H04M 2250/16; H04M 2250/52

(57) ABSTRACT

A back-attached display apparatus for mobile phone selfie taking includes: a display screen detachably arranged on a back of a mobile phone and configured to synchronously display a shot scene of a rear camera; a data cable having one end for being connected with the display screen and the other end for being connected with the external mobile phone; and a remote controller configured to be in communication connection with the mobile phone and send a shooting instruction to the mobile phone. The display screen is arranged on the back of the mobile phone, and the scene of the rear camera in a normal shooting state is displayed in the display screen on the back of the mobile phone, so that a user can view a view-finding composition in real time and autonomously adjust a posture and a position without the help of another person or an external device.

### CROSS REFERENCE TO THE RELATED APPLICATIONS

This application is based upon and claims priority to Chinese Patent Application No. 202411809386.0, filed on Dec. 10, 2024, the entire contents of which are incorporated herein by reference.

### TECHNICAL FIELD

The present invention pertains to the field of mobile phone camera shooting accessory technologies, and particularly relates to a back-attached display apparatus for mobile phone selfie taking.

### BACKGROUND

In a current smart phone, due to cost and structure limitations, imaging quality of a front camera is significantly lower than that of a rear main camera, so that a user (such as a travel enthusiast) often has to choose to ask another person to assist shooting with the rear camera when needing high-quality selfie taking or taking of a photo as a memento. However, this approach has the double limitations that the assister has poor photography skills or a comprehending deviation to result in a poor effect of a final photo, and an available assister is difficult to find in certain scenarios. Although a delayed selfie taking function as an alternative solution can allow the user to trigger the rear camera to perform shooting, since the user is in front of a lens, the user cannot observe a view-finding scene in real time and cannot adjust a posture and a position thereof in real time according to an actual composition, so that repeated trial photographing is caused to result in a low efficiency, and a clear photo with a satisfactory composition cannot be obtained efficiently.

### SUMMARY

The present invention aims to provide a back-attached display apparatus for mobile phone selfie taking, which solves the technical problem that another person is required to assist shooting during photographing by a rear camera of an existing mobile phone.

In order to solve the above technical problem, the following technical solution is adopted in the present invention:
a back-attached display apparatus for mobile phone selfie taking includes:
a display screen detachably arranged on a back of a mobile phone and configured to synchronously display a shot scene of a rear camera of the mobile phone;
a data cable having one end for being connected with the display screen and the other end for being connected with the external mobile phone; and
a remote controller configured to be in communication connection with the mobile phone and send a shooting instruction to the mobile phone.

Further, the display screen is connected with the back of the mobile phone through a magnetic attraction part or a sucking disc.

Further, the display screen is provided therein with a first magnetic attraction part, and the display screen is attached to the back of the mobile phone by the first magnetic attraction part.

Further, the display screen further includes a face shell, a printed circuit board assembly (PCBA) board and a bottom cover, the face shell is connected with the bottom cover to form an accommodating cavity, a screen assembly is arranged on an upper surface of the face shell, the PCBA board is arranged in the accommodating cavity, and the screen assembly is connected with the PCBA board through a flat cable; an interface of the display screen is arranged on the PCBA board, a slot for exposing the interface of the display screen is arranged in a side surface of the face shell, and the first magnetic attraction part is arranged on the PCBA board and close to the bottom cover.

Further, the face shell is further provided with an on-off key, and the on-off key is connected with the PCBA board.

Further, the face shell is connected with the bottom cover by a buckle.

Further, the remote controller is in communication connection with the mobile phone through Bluetooth or wireless fidelity (Wi-Fi).

Further, at least one end of the data cable is provided with an anti-dropping base with a through hole, and the other end of the data cable penetrates through the through hole and then is configured to be connected with the display screen or the external mobile phone.

Further, the remote controller is attached to one end of the data cable in a magnetic attraction mode.

Further, the remote controller is magnetically attracted to the end of the data cable penetrating through the through hole of the anti-dropping base.

Further, the remote controller is of a structure with a middle recessed inwards to form a notch groove, and the notch groove is configured to clamp one end of the data cable.

Further, the remote controller is further provided therein with a second magnetic attraction part, the second magnetic attraction part corresponds to the notch groove, and the remote controller is connected with one end of the data cable in a magnetic attraction mode by the second magnetic attraction part.

Further, a rechargeable battery is arranged in the remote controller, and a charging interface is arranged in the remote controller; the remote controller is further provided with a shooting control key and a charging state indicator lamp.

Compared with the prior art, the present invention has the following beneficial effects: in the present invention, the display screen is arranged on the back of the mobile phone, and the scene of the rear camera in a normal shooting state is displayed in the display screen, so that a user can view a view-finding composition in real time and autonomously adjust a posture and a position without the help of another person or an external device, thereby efficiently completing a selfie taking operation or the operation of taking a photo as a memento; the display apparatus has a compact structure and is convenient to carry, and control convenience and use experience of mobile phone rear shooting are obviously improved; through an integrated design of the remote controller and the data cable, an operation process of the user is simplified, the risk of device loss or mismatching is reduced, and the display apparatus is suitable for various shooting scenarios, and is particularly suitable for applications, such as single-person selfie taking and remote stop-motion shooting.

The display apparatus not only effectively overcomes the problems of composition blind shooting and frequent trial-and-error operations of delayed selfie taking in the prior art, but also avoids communication errors and uncertainty caused by dependence on shooting by another person, and improves user imaging autonomy, convenience and photo quality in scenarios, such as traveling and independent shooting.

### BRIEF DESCRIPTION OF THE DRAWINGS

The accompanying drawings are used to provide a further understanding of the present invention, constitute a part of the specification, illustrate the present invention together with the embodiments thereof, and do not limit the present invention. In the drawings:

FIG. 1 is a schematic structural diagram of a back-attached display apparatus for mobile phone selfie taking according to the present invention;

FIG. 2 is a use state diagram of the back-attached display apparatus for mobile phone selfie taking according to the present invention;

FIG. 3 is an isometric view of a display screen;

FIG. 4 is an exploded view of the display screen;

FIG. 5 is an isometric view of a data cable;

FIG. 6 is a top state view of the data cable;

FIG. 7 is a sectional view taken along A-A in FIG. 6;

FIG. 8 is an isometric view of a remote controller; and

FIG. 9 is an exploded view of the remote controller.

### DETAILED DESCRIPTION OF THE EMBODIMENTS

The technical solutions in the embodiments of the present invention are clearly and completely described with reference to the accompanying drawings in the embodiments of the present invention, and apparently, the described embodiments are not all but only a part of the embodiments of the present invention. All other embodiments obtained by a person of ordinary skill in the art based on the embodiments of the present invention without creative efforts shall fall within the protection scope of the present invention.

The present invention is described in further detail below with reference to embodiments.

A first embodiment of a back-attached display apparatus for mobile phone selfie taking according to the present invention is as follows.

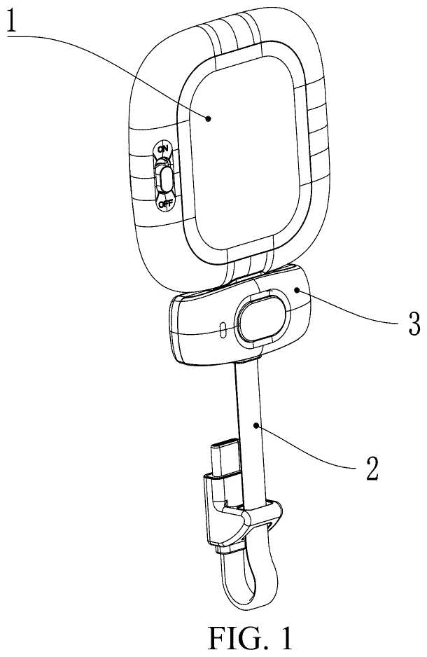

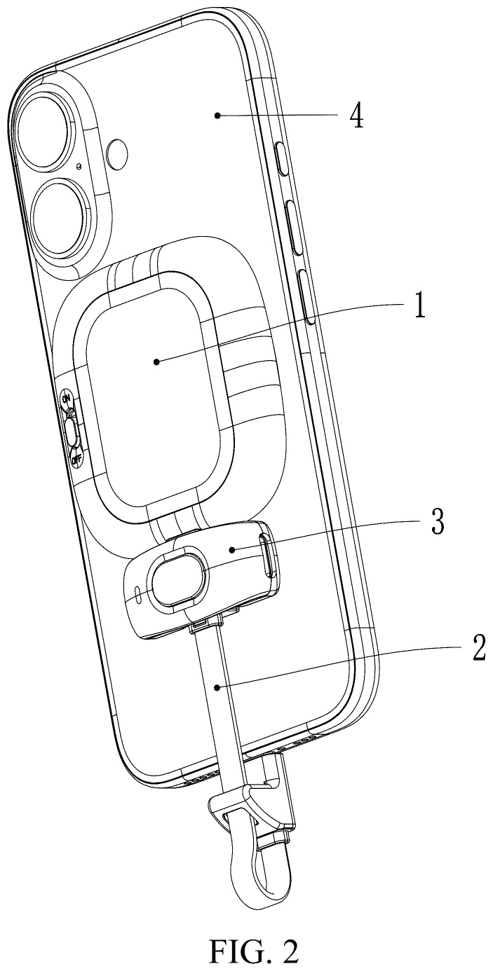

As shown in FIGS. 1-2, the back-attached display apparatus for mobile phone selfie taking includes a display screen 1, a data cable 2 and a remote controller 3; wherein the display screen 1 is detachably connected to a back of a mobile phone 4 and configured to synchronously display a shot scene of a rear camera of the mobile phone 4, the detachable mode may be magnetic attraction connection or sucking disc fixation, and preferably, in the present embodiment, the display screen 1 is attached to the back of the mobile phone 4 in a magnetic attraction mode, so that a structure is simpler, an occupied space is small, mounting is convenient, and a user operation and carrying are facilitated.

One end of the data cable 2 is configured to be connected with the display screen 1, the other end of the data cable is configured to be connected with the external mobile phone 4, and the data cable 2 is configured to realize data communication between the mobile phone 4 and the display screen 1 and meanwhile supply power to the display screen 1.

The remote controller 3 is configured to send a shooting instruction to the mobile phone 4, and is connected with the mobile phone 4 in a wireless communication mode, and the wireless communication mode can be Bluetooth, Wi-Fi, a mobile hotspot, or the like.

In an actual use process, a user attaches the display screen 1 to the back of the mobile phone 4 and connects the display screen 1 with the mobile phone 4 through the data cable 2, and at this point, the display screen 1 and the rear camera are located on the same side of the mobile phone 4. When needing to perform selfie taking with the rear camera, the user faces the rear camera, the shot scene thereof is synchronously displayed on the display screen 1, and the user can adjust a posture and a composition angle thereof in real time according to display content. After a composition is satisfactory, a shooting operation can be completed by controlling the remote controller 3 to send a shooting command to the mobile phone 4.

The back-attached display apparatus for mobile phone selfie taking according to the present embodiment can effectively avoid the problem of an inaccurate composition caused by view-finding blind shooting in traditional rear selfie taking, and meanwhile does not need to rely on assistance of another person, thus improving autonomy and an imaging efficiency of selfie taking.

A second embodiment of the back-attached display apparatus for mobile phone selfie taking according to the present invention is as follows.

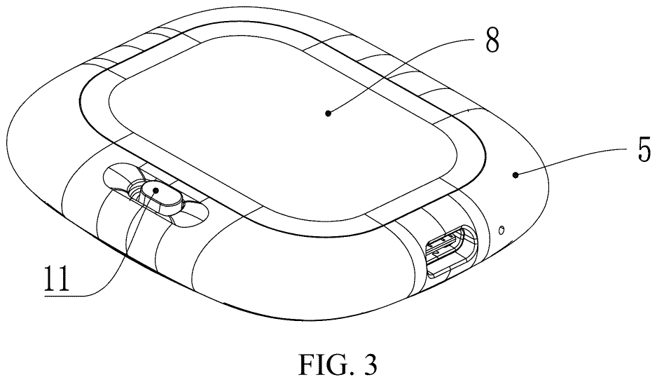

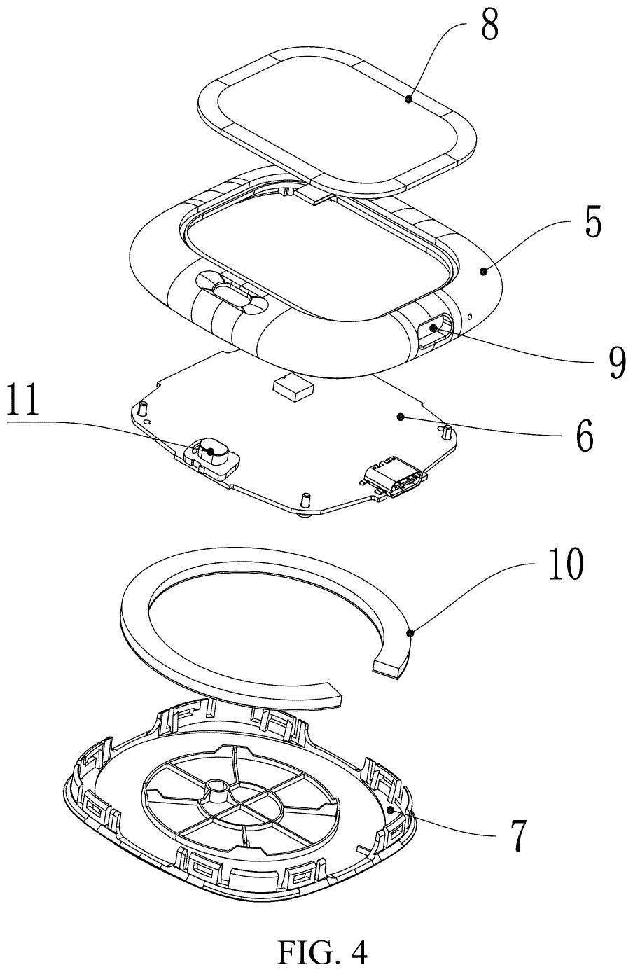

Referring to FIGS. 2-3, the present embodiment further discloses a specific structure of the display screen 1, which includes a face shell 5, a first PCBA board 6 and a bottom cover 7, wherein the face shell 5 is connected with the bottom cover 7 through a buckling structure, a first accommodating cavity is formed between the face shell 5 and the bottom cover 7, a screen assembly 8 is arranged on an upper surface of the face shell 5, the first PCBA board 6 is arranged in the first accommodating cavity, and the screen assembly 8 is connected with the first PCBA board 6 through a flat cable; an interface of the display screen 1 is arranged in the first PCBA board 6, a side surface of the face shell 5 is provided with a slot 9 for exposing the interface of the display screen 1, a first magnetic attraction part 10 is arranged in the bottom cover 7, and the first magnetic attraction part 10 is in a major arc shape; the display screen 1 can be attached to the back of the mobile phone 4 through the first magnetic attraction part 10.

In the present embodiment, the face shell 5 and the bottom cover 7 may be directly bonded by bolts or adhesive.

In order to realize convenient control, the face shell 5 is provided with an on-off key 11 for switching on or off the display screen 1, and the on-off key 11 is electrically connected to the first PCBA board 6; when the user needs to perform selfie taking, the on-off key 11 is switched on, and the display screen 1 can synchronously display the scene of the camera of the mobile phone 4; after use, the on-off key 11 is switched off, a system is powered off, the display screen 1 is switched off, and the operation is simple, convenient, energy-saving and efficient.

A third embodiment of the back-attached display apparatus for mobile phone selfie taking according to the present invention is as follows.

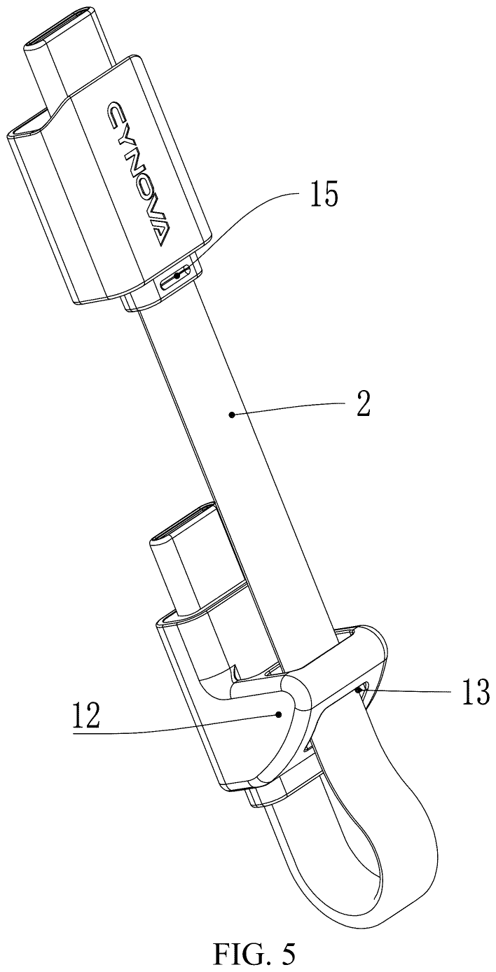

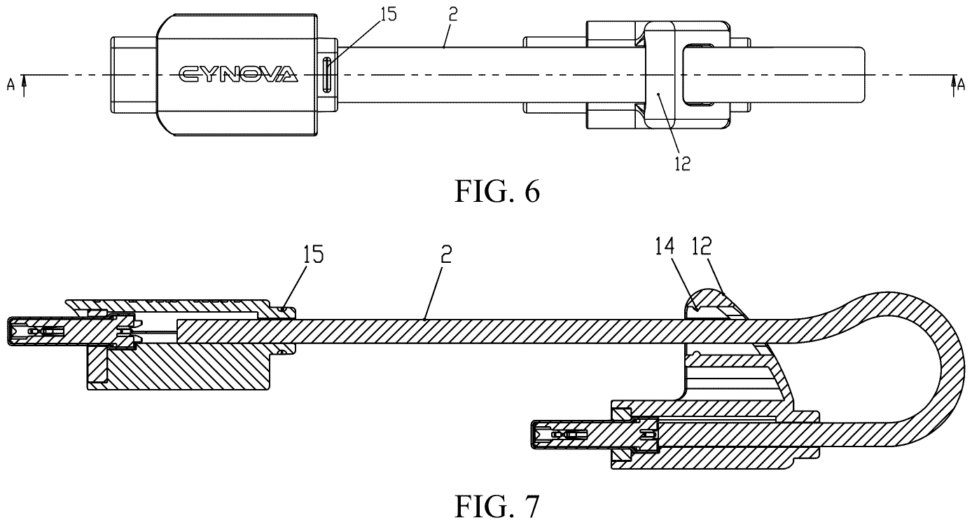

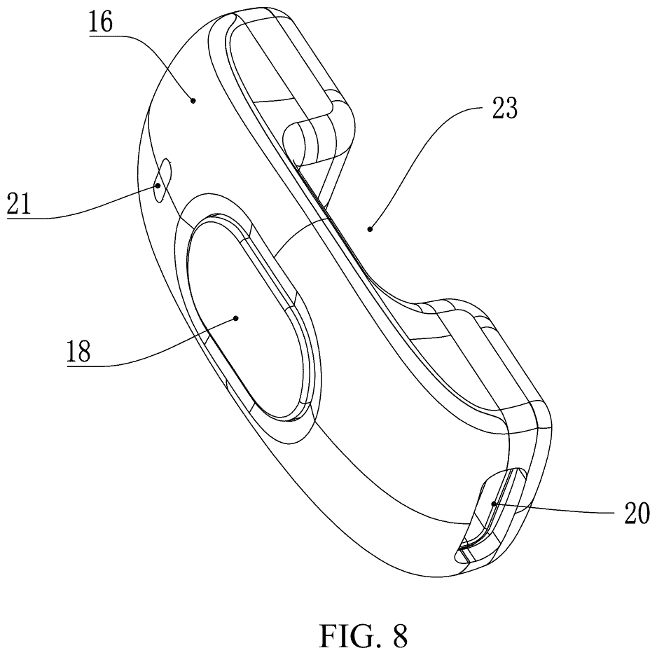

As shown in FIGS. 5-7, the present embodiment improves the structure of the data cable 2 to solve an irregular problem during use and storage.

The two ends of the data cable 2 are connected to the mobile phone 4 and the display screen 1 respectively, an interface in the mobile phone 4 is usually located at a bottom, and therefore, the data cable 2 is usually in a half-folded state in actual use. When an end portion of the data cable 2 is not connected with the mobile phone 4 or the display screen 1, a cable body is prone to be loosened and unfolded, thus affecting attractiveness and convenient storage. Therefore, in the present embodiment, an anti-dropping base 12 is arranged at the end portion of the data cable 2 connected with the mobile phone 4, the anti-dropping base 12 is of a ridge-shaped convex structure (as shown in FIG. 5), a through hole 13 is formed in the anti-dropping base 12, and the other end of the data cable 2 penetrates through the through hole 13 and then is connected with the display screen 1.

With the above structure, the data cable 2 is fixed by the anti-dropping base 12 after penetrating through the through hole 13, and the cable body is kept in the half-folded state, so that the data cable can be stably connected in use, and is convenient to neatly store when not used, so as to save a space. Meanwhile, the user can freely adjust a length of a part of the data cable 2 penetrating out of the through hole 13 according to a mounting position of the display screen 1 on the back of the mobile phone 4, thus improving operation flexibility.

Further, in order to improve storage stability, two opposite positioning protrusions 14 are arranged on an inner wall of the through hole 13 of the anti-dropping base 12, and two positioning grooves 15 which are matched with the positioning protrusions 14 are arranged on a lower side of the end portion of the end of the data cable 2 connected with the display screen 1. When the data cable 2 is not used, the end portion thereof can be partially inserted into the through hole 13 and in clamping fit with the positioning protrusion 14, so that the end portion of the data cable 2 is fixedly stored and prevented from loosening or dropping.

A fourth embodiment of the back-attached display apparatus for mobile phone selfie taking according to the present invention is as follows.

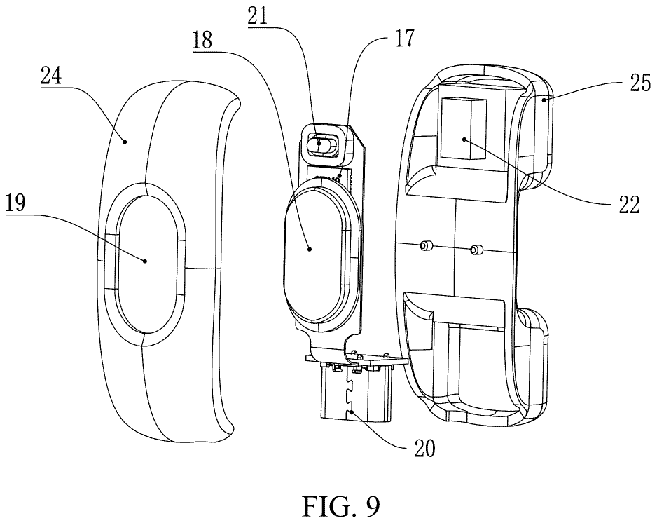

In the present embodiment, further optimization is performed on the basis of the third embodiment, and as shown in FIGS. 8-9, a specific structure of the remote controller 3 is disclosed, and includes an outer housing 16, a second PCBA board 17 is arranged in the outer housing 16, a Bluetooth module, a shooting control key 18 and a power source are integrated on the second PCBA board 17, and the Bluetooth module is configured to establish wireless connection with the mobile phone 4 to achieve a remote shooting control function; the outer housing 16 is provided with a key hole 19 corresponding to the shooting control key 18, and the shooting control key 18 is located in the key hole 19.

The power source supplies power to the Bluetooth module and the second PCBA board 17, and preferably, the power source is a rechargeable battery, a charging interface 20 and a charging state indicator lamp 21 are connected to the second PCBA board 17, the charging interface 20 is configured to charge the rechargeable battery, and the charging state indicator lamp 21 is arranged on the outer housing 16 and configured to indicate a charging state of the battery, thus improving use convenience.

In order to facilitate storage of the remote controller 3 when the remote controller 3 is not used, a second magnetic attraction part 22 is further arranged in the outer housing 16, and the remote controller 3 is attached to one end of the data cable 2 through the second magnetic attraction part 22, so as to realize temporary fixation and facilitate carrying and management.

As another embodiment of the present invention, the outer housing 16 is formed by buckling an upper shell 24 and a lower shell 25, a second accommodating cavity for accommodating internal elements is formed between the upper shell 24 and the lower shell 25, the lower shell 25 is of a structure with a middle recessed inwards to form a notch groove 23, the notch groove 23 is configured to clamp one end (the end connected with the display screen 1) of the data cable 2, and a size of the notch groove 23 is matched with that of the end portion of the data cable 2, so as to realize a good clamping fit and improve structural stability; the second magnetic attraction part 22 is arranged in the second accommodating cavity and corresponds to the notch groove 23 in position, so as to enhance a magnetic attraction effect between the remote controller 3 and the end portion of the data cable 2, and further guarantee firm and safe storage of the remote controller 3.

A specific application scenario is as follows.

When performing selfie taking with the mobile phone, the user firstly attaches the display screen 1 to the back of the mobile phone 4 in the magnetic attraction mode or through a sucking disc, and connects the display screen 1 with the mobile phone 4 through the data cable 2; when the rear camera of the mobile phone 4 is aligned with the user, the scene of the rear camera of the mobile phone 4 is displayed in the display screen 1, and when the eyes of the user look at the rear camera for shooting, the user can see the current shooting posture at the same time and can adjust the shooting posture in real time; the shooting posture cannot be influenced by adjusting the posture of the body due to the need of observing the current shooting posture of the user; after the adjustment, the user controls the mobile phone 4 to perform shooting through the Bluetooth remote controller 3; the user can attach the Bluetooth remote controller 3 on the data cable 2 after the shooting, so as to prevent the Bluetooth remote controller 3 from losing.

When performing selfie taking, the user holds the mobile phone 4 with one hand, and holds the remote controller 3 with the other hand; or the user holds a selfie stick with one hand, and the mobile phone 4 is mounted on the selfie stick; the user holds the remote controller 3 with the other hand.

In the present invention, a shooting device can be a tablet personal computer or other mobile devices besides the mobile phone 4; use of the apparatus according to the present invention for shooting of other mobile devices is an infringement.

It should be noted that the term “comprising”, “including”, or any other variant thereof herein is intended to encompass a non-exclusive inclusion, so that the process, method, article or device including a series of elements does not only include those elements, but also includes other elements not explicitly listed, or further includes inherent elements of the process, method, article or device.

Although embodiments of the present invention have been shown and illustrated, it shall be understood by those skilled in the art that various changes, modifications, alternatives and variants without departing from the principle and spirit of the present invention are acceptable. The scope of the present invention is defined by the appending claims and equivalents thereof.

What is claimed is:

1. A back-attached display apparatus for mobile phone selfie taking, comprising:
a display screen detachably arranged on a back of a mobile phone and configured to synchronously display a shot scene of a rear camera of the mobile phone;
a data cable having a first end for being connected with the display screen and a second end for being connected with the mobile phone; and
a remote controller configured to be in communication connection with the mobile phone and send a shooting instruction to the mobile phone.

2. The back-attached display apparatus for the mobile phone selfie taking according to claim 1, wherein the display screen is connected with the back of the mobile phone through a magnetic attraction part or a sucking disc.

3. The back-attached display apparatus for the mobile phone selfie taking according to claim 2, wherein the display screen is provided therein with a first magnetic attraction part, and the display screen is attached to the back of the mobile phone by the first magnetic attraction part.

4. The back-attached display apparatus for the mobile phone selfie taking according to claim 3, wherein the display screen further comprises a face shell, a printed circuit board assembly (PCBA) board, and a bottom cover, the face shell is connected with the bottom cover to form an accommodating cavity, a screen assembly is arranged on an upper surface of the face shell, the PCBA board is arranged in the accommodating cavity, and the screen assembly is connected with the PCBA board through a flat cable; an interface of the display screen is arranged on the PCBA board, a slot for exposing the interface of the display screen is arranged in a side surface of the face shell, and the first magnetic attraction part is arranged on the PCBA board and adjacent to the bottom cover.

5. The back-attached display apparatus for the mobile phone selfie taking according to claim 4, wherein the face shell is further provided with an on-off key, and the on-off key is connected with the PCBA board.

6. The back-attached display apparatus for the mobile phone selfie taking according to claim 4, wherein the face shell is connected with the bottom cover by a buckle.

7. The back-attached display apparatus for the mobile phone selfie taking according to claim 1, wherein the remote controller is in the communication connection with the mobile phone through Bluetooth or wireless fidelity (Wi-Fi).

8. The back-attached display apparatus for the mobile phone selfie taking according to claim 1, wherein at least one end of the data cable is provided with an anti-dropping base with a through hole, and the first end of the data cable or the second end of the data cable penetrates through the through hole and then is configured to be connected with the display screen or the mobile phone.

9. The back-attached display apparatus for the mobile phone selfie taking according to claim 8, wherein the remote controller is attached to the first end of the data cable in a magnetic attraction mode.

10. The back-attached display apparatus for the mobile phone selfie taking according to claim 9, wherein the remote controller is magnetically attracted to the first end of the data cable penetrating through the through hole of the anti-dropping base.

11. The back-attached display apparatus for the mobile phone selfie taking according to claim 1, wherein the remote controller is of a structure with a middle recessed inwards to form a notch groove, and the notch groove is configured to clamp the first end of the data cable.

12. The back-attached display apparatus for the mobile phone selfie taking according to claim 11, wherein the remote controller is further provided therein with a second magnetic attraction part, the second magnetic attraction part corresponds to the notch groove, and the remote controller is connected with the first end of the data cable in a magnetic attraction mode by the second magnetic attraction part.

13. The back-attached display apparatus for the mobile phone selfie taking according to claim 12, wherein a rechargeable battery is arranged in the remote controller, and a charging interface is arranged in the remote controller; and the remote controller is further provided with a shooting control key and a charging state indicator lamp.
